(19) United States
(12) Patent Application Publication
(10) Pub. No.: US 2023/0266731 A1
(43) Pub. Date: Aug. 24, 2023

(54) Digital Twin-Based Process Control in an IoT Network

(71) Applicant: Siemens Aktiengesellschaft, München (DE)

(72) Inventors: Markus Sauer, München (DE); Thomas Jetzfellner, Aschheim (DE)

(73) Assignee: Siemens Aktiengesellschaft, München (DE)

(21) Appl. No.: 18/006,431

(22) PCT Filed: Jul. 9, 2021
(86) PCT No.: PCT/EP2021/069195

§ 371 Date: Jan. 23, 2023

(30) Foreign Application Priority Data
Jul. 27, 2020 (EP) 20187963.2

(51) Int. Cl. G05B 19/042

(52) U.S. Cl. CPC G05B 19/042; G05B 2219/25011

(57) ABSTRACT

Various embodiments of the teachings herein include a method for validating a transaction for execution by a node of a technical system. The method may include: acquiring a transaction comprising control commands to be executed by the technical system; determining a validation requirement for the transaction; transferring the transaction and the validation requirement to a digital simulation of the technical system; and executing the transaction in the digital simulation to establish whether the transaction can be executed according to the validation requirement.

### CROSS-REFERENCE TO RELATED APPLICATIONS

This application is a U.S. National Stage Application of International Application No. PCT/EP2021/069195 filed Jul. 9, 2021, which designates the United States of America, and claims priority to EP Application No. 20187963.2 filed Jul. 27, 2020, the contents of which are hereby incorporated by reference in their entirety.

### TECHNICAL FIELD

The present disclosure relates to networks. Various embodiments may include nodes in a control network, in particular a DLT-based IoT network, corresponding networks, methods, computer programs and/or electronically readable data carriers.

### BACKGROUND

The networking of edge devices and Internet of Things (“IoT”) devices is an important aspect in the digital industrial sphere. In particular, forming ecosystems in which these corresponding devices or a multiplicity of such devices communicate with one another in order to control processes is a challenge.

Communication in systems with different device manufacturers or device owners who do not necessarily trust one another is a particular challenge here. For a few years, communication infrastructures (also called IoT infrastructures) have been available which allow trustworthy communication between such devices even in an environment classified as not trustworthy, and possibly without a central third party building up trust. Distributed ledger technologies (DLT) are an example of such a technology.

When a process (e.g. a manufacturing process, a control process of a complex (town/city) infrastructure) is processed by a multiplicity of different IoT devices in a heterogeneous IoT network, it is unclear whether and how this process can be executed or whether optimizations are necessary for its execution. Particularly in a semi-automated or fully automated IoT control infrastructure with various stakeholders in which parts of the processes have to be adapted dynamically during execution of the process, the execution of the process may be interrupted or even terminated. In conventional solutions, a technician monitors the execution of the process on site and intervenes manually, if appropriate.

### SUMMARY

Therefore, there is a need for improved techniques for the control of a technical system which overcome or alleviate at least some of the limitations and disadvantages mentioned. For example, some embodiments of the teachings herein include a node (110) of a network (100) for controlling a technical system, configured for: acquiring a transaction (120) comprising control commands which are intended to be executed by the technical system; determining a validation requirement (130) for the at least one transaction (120); transferring the transaction (120) and the validation requirement (130) to a digital simulation (200) of the technical system; and executing the control commands by means of the digital simulation (200) in order to establish whether the transaction (120) can be executed according to the validation requirement (130).

In some embodiments, if it was established that the transaction (120) can be executed according to the validation requirement (130), further configured for validating the transaction (120) for execution by the technical system, in particular storing the transaction (120) in the network (100).

In some embodiments, if it was established that the transaction (120) cannot be executed according to the validation requirement (130), further configured for: adapting the control commands using the digital simulation (200) in order to find adapted control commands, and executing the adapted control commands (120) by means of the digital simulation (200) in order to establish whether the adapted control commands (120) can be executed according to the validation requirement (130), and if it is established that the adapted control commands can be executed by the technical system, validating the adapted control commands as new transaction (120) for execution by the technical system.

In some embodiments, exclusively a transaction (120) whose executability was confirmed by means of transferring to the digital simulation (200) and simulating the control commands in the digital simulation (200) is validated for execution by the technical system.

In some embodiments, the digital simulation (200) is a digital twin of the technical system and/or of the network (100).

In some embodiments, the network (100) is a network application or an infrastructure of a network application or a distributed database (200) without a central entity, in particular a database based on a distributed ledger technology.

In some embodiments, the technical system together with the network (100) for controlling the technical system is an Internet of Things (IoT) system.

In some embodiments, the node (110) is designed to store the transaction (120) in a blockchain.

In some embodiments, if it was established that the transaction (120) can be executed according to the validation requirement (130), configured for transferring the transaction (120), on the basis of the successful simulation by the digital simulation (200), to the node (110) which is intended to execute the transaction (120), by means of a transfer mechanism which is independent of a complete data replication in the network (100), in particular by means of a transfer mechanism which is accelerated by comparison with the complete data replication.

In some embodiments, the accelerated transfer mechanism comprises a component identical or similar to a Lightning protocol.

In some embodiments, upon execution of the transaction (120) by the technical system, a quality of the validation of a node (210) of the digital simulation (200) is determined by comparing the transaction (120) validated by the digital simulation (200) with the real execution of the transaction (120) by the technical system.

In some embodiments, the quality of the validation of a node (210) of the digital simulation (200) is used to determine for the node (210) of the digital simulation (200) a dynamic weighting factor relative to other nodes (210) of the digital simulation (200), which factor is used in the validation of a following transaction (120).

In some embodiments, instead of one transaction (120), a multiplicity of transactions (120) are validated for execution by a respective corresponding node (110) of the technical system, configured for: acquiring a multiplicity of transactions (120), each comprising control commands which are intended to be executed by a corresponding node (110) of the mechanical installation; determining an associated validation requirement (130) for a respective transaction (120); transferring the transactions (120) and the associated validation requirements (130) to a digital simulation (200) of the technical system; executing the transactions (120) in the digital simulation (200) in order to establish whether the transactions (120) can be executed according to the associated validation requirements (130); and if it was established that a predefined minimum number of nodes (210) of the digital simulation (200) can execute the corresponding transactions (120) according to the associated validation requirements (130), validating all the transactions (120) for execution by the technical system.

As another example, some embodiments include a method for validating a transaction for execution by a node (110) of a technical system, comprising: acquiring a transaction comprising control commands which are intended to be executed by the technical system; determining a validation requirement (130) for the at least one transaction; transferring the transaction and the validation requirement (130) to a digital simulation (200) of the technical system; and executing the transaction in the digital simulation (200) in order to establish whether the transaction can be executed according to the validation requirement (130).

As another example, some embodiments include a network (100) for controlling a technical system, comprising a node (110) as described herein.

### BRIEF DESCRIPTION OF THE DRAWINGS

The teachings herein are explained in greater detail below on the basis of exemplary embodiments with reference to the accompanying drawings. In the figures, identical reference signs designate identical or similar elements. The figures are schematic illustrations of various exemplary embodiments of the teachings herein, wherein the elements illustrated in the figures are not necessarily illustrated in a manner true to scale. Rather, the various elements illustrated in the figures are rendered in such a way that their function and general purpose become comprehensible to a person skilled in the art.

FIG. 1 schematically shows a network node incorporating teachings of the present disclosure;

FIG. 2 schematically shows an IoT infrastructure incorporating teachings of the present disclosure;

FIG. 3 schematically shows a digital simulation of the IoT infrastructure from FIG. 2; and

FIG. 4 shows a flow diagram with steps for a network node incorporating teachings of the present disclosure.

### DETAILED DESCRIPTION

Features, advantages or alternative exemplary embodiments can be assigned to the respective other claimed categories, and vice versa. In other words, the various embodiments of a network node and/or IoT infrastructure may incorporate features described in the context of the example methods, and vice versa. For example, a network is configured for controlling a technical system. The network comprises a plurality of network nodes configured to acquire a transaction, to forward it to other nodes, and/or to store it in the network. The transaction comprises control commands which are intended to be executed by the technical system. In other words, the control commands of the technical system and/or of the network may not be executed, and be intended for execution by the technical system and/or the network.

In some embodiments, the network nodes of the control network are each connected to a component of the technical system, or comprise the component of the technical system, wherein a node can receive transactions which are executed by a corresponding component of the technical system.

In some embodiments, in a network transactions are transmitted to a plurality of nodes of the network, wherein a respective transaction can comprise control commands for execution by a component of the technical system. Such a control network can comprise, for example, as an Internet of Things system, a P2P network, a decentralized network structure, i.e. without a central trustworthy entity, a decentralized distributed database, a DLT-based database, a blockchain, or an arbitrary combination thereof.

The node may be configured to receive a transaction, comprising control commands which are intended to be executed by the technical system. The node is further configured for determining a validation requirement for the transaction. The node is further configured for transferring the transaction and the validation requirement to a digital simulation of the technical system. The control commands are executed in the digital simulation in order to establish whether the transaction can be executed according to the validation requirement. In other words, simulated execution of the transaction by the digital simulation makes it possible to establish whether and/or how, for example under what conditions or requirements, and/or by what components/devices of the technical system, the transaction can be executed. These results of the digital simulation can subsequently be used to schedule the transaction for execution by the real technical system and/or to execute it.

The transaction can be carried out by one or more of the nodes of the network. In one example, a first node can acquire the transaction, and the digital simulation can be executed before the transaction is distributed to further nodes in the network. In some examples, the digital simulation of the transaction can determine which node(s) of the technical system is/are intended to acquire the transaction for execution. In other words, the node which acquires the transaction can forward the transaction to the digital simulation, in other words invoke or initiate the digital simulation checking.

In some embodiments, the digital simulation can be designed separately from the control network, or can be realized as a dedicated part of the network, in particular as a dedicated node or computer of the network, or can be realized on a node which is connected to a component of the technical system and carries out control tasks in the technical system.

In some embodiments, the node can be further configured, if the digital simulation establishes that the transaction can be executed according to the validation requirement, to validate the transaction for execution by the technical system. Validating a transaction can comprise storing the transaction in the network. In other words, validating can comprise temporally planning execution of the transaction, or enabling the transaction. In some examples, a transaction which was not validated cannot be stored, and/or cannot be executed by the technical system, i.e. can be discarded.

In some embodiments, the digital simulation confirms to the initiating node that the transaction can be executed by the technical system and optionally which component(s) of the technical system can execute the transaction, and the initiating one of the nodes forwards the transaction to the network or to the corresponding nodes for execution.

As another example, a method for a node of a network may include the following elements. In one step, a transaction is acquired, which can comprise one or a plurality of instructions for the technical system, tasks for the technical system, in particular control commands for the technical system, program instructions, a control program, a computer program, a smart contract, and/or chain code, which are intended to be executed by the technical system. By way of example, the transaction is communicated or transmitted to the node, and/or received by the node. In a further step, a validation requirement for the transaction is determined. In a further step, the transaction and the validation requirement are transferred to a digital simulation of the network and/or of the technical system. In a further step, the transaction, i.e. the control commands, is executed in simulated fashion in the digital simulation in order to establish whether the transaction can be executed according to the validation requirement. If the transaction can be executed by the digital simulation, in other words can be executed successfully, then in a further step the node can acquire a confirmation by the digital simulation, and in a further step accept or validate the transaction for the real technical system.

In some embodiments, validating the transaction comprises storing the transaction in a network application, a distributed database, in particular a DLT-based database, or a blockchain. Transactions which were stored for execution can subsequently be executed by the technical system; by way of example, only validated transactions can be executed by the technical system. A network application can be for example a database, a distributed database, a cloud, a cloud service, a (distributed) ledger, an IoT infrastructure or a blockchain or can be implemented by means of the examples just mentioned.

The IoT infrastructure can be a network, such as, for example, an automation network, a control network, a P2P network, and can include a database, such as, for example, a distributed database, in particular a distributed ledger technology (DLT)-based network, or a blockchain-based network.

In some embodiments, a transaction which is intended to be executed by a technical system is first simulated in a digital twin of the technical system, it being possible to determine additional parameters for execution by the real system, and is validated on the basis thereof and/or stored in a DLT-based database within the network.

The method described herein thus make it possible to use a network application (e.g. a blockchain or a distributed database system) for industrial application primarily in the field of manufacturing. In this case, temporal requirements can be predefined, for example, by way of the configurability and the selectability of the validation and/or transfer. The network application validates only those transactions which can be executed by a corresponding network application-based (e.g. blockchain-based) manufacturing system by virtue of a predefined number of nodes confirming that these execute the transactions. This ensures that only executable or potentially executable transactions become part of the network application (e.g. blockchain). This is important particularly if such a system is realized as an open ecosystem in which the validation of possible transactions is not realized by a third party.

As another example, a network for controlling a technical system comprises one or more nodes incorporating teachings of the present disclosure. The node and the network can be configured to carry out an arbitrary method or an arbitrary combination of methods described herein.

As another example, some embodiments include a computer program comprising instructions which, when the program is executed by a processor, cause the latter to perform the steps of an arbitrary method in accordance with the present disclosure.

As another example, some embodiments include an electronically readable data carrier storing instructions which, when executed by a processor, cause the latter to perform the steps of one or more of the methods described herein.

For such a network, computer program and electronically readable data carrier, it is possible to attain technical effects which correspond to the technical effects for the methods described herein.

Although the features described in the above summary and the following detailed description are described in association with specific examples, it should be understood that the features can be used not only in the respective combinations but also in isolation or in arbitrary combinations, and features from different examples for the methods, network nodes and IoT infrastructures can be combined with one another and correlate with one another, unless expressly indicated otherwise.

Therefore, the above summary is intended to give only a brief overview of some features of some embodiments and implementations and should not be understood as a limitation. Further embodiments can comprise features other than those described above. The above-described properties, features and advantages of the teachings herein and the way in which they are achieved will become clearer and more clearly understood in association with the following description of exemplary embodiments which are explained in greater detail in association with the figures.

The drawings should be regarded as schematic illustrations and the elements illustrated in the drawings are not necessarily illustrated in a manner true to scale. Rather, the various elements are illustrated such that their function and their general purpose become apparent to a person skilled in the art. It should be noted here that the description of the exemplary embodiments should not be understood in a restrictive sense. The scope of the disclosure is limited by the exemplary embodiments described below or by the figures, which serve only for elucidation.

A description is given below of various techniques for controlling processes in an IoT infrastructure, in particular a digital twin-based execution optimization of control commands in a network application, e.g. a distributed database or a heterogeneous IoT network. The techniques disclosed can be used particularly advantageously in a decentralized control network of a technical system, in particular an IoT network having IoT devices and edge devices as nodes. The decentralized control network can for example comprise a network application, a distributed database, a DLT-based database, or a blockchain, or be designed as such. In such a decentralized distributed network structure, for example, a multiplicity of equally authorized nodes can, among one another, exchange data, forward data, transmit data, receive data and/or store data in a tamper-proof manner in a DLT-based database, for example in a tamper-proof manner in a blockchain.

Various examples disclose a validation of transactions for an Internet of Things (IoT) network with the aid of a digital twin. A node of the network transfers a transaction which is intended to be executed in the IoT network, and a validation requirement of the transaction, to a digital twin of the IoT network. Simulated execution of the transaction establishes whether the transaction can be executed according to the validation requirement. It is only after successful simulation that the node validates the transaction for the IoT network and transfers the transaction for distributed storage within the IoT network.

A node can thus comprise for example a network node (e.g. of the network application), a database node, an IoT device or an edge device of an industrial IoT system, a control device for a component of a technical system, a node of a blockchain or of a DLT-based database, or an arbitrary combination thereof. The term node, or network node, is intended to be interpreted in the context of the disclosure such that it includes electronic devices which can process and/or store data, and can include for example a component of a technical system. Network nodes can contain a processor, a memory, and an interface to a control network.

A transaction can comprise for example one or more data units, data blocks, control commands, control information items, sensor data of a technical system, data input by a user, and generally data which were generated in the network, or which are acquired by the network, and/or are distributed. In particular, a transaction can comprise one or more data blocks stored within a network application such as a DLT-based database, in particular a blockchain. A transaction can for example also be designed as a message, comprising a data structure, which comprises data units, data blocks, control commands, control information items, sensor data of a technical system, data input by a user, and generally data which were generated in the network, or which are acquired by the network, and/or are distributed.

A “network application” or a “distributed database” (can e.g. also be referred to as a distributed database system) can be a database or network application which is distributed over a multiplicity of calculating nodes (e.g. network nodes), wherein transactions to the network application or database depend on a consensus between the network nodes and wherein the network nodes can be distributed geographically over a plurality of locations, sites, countries or organizations. Such a consensus can be produced by a consensus algorithm such as, for example, proof-of-work, proof-of-stake or a voting system. In particular, the network application or the distributed database can be implemented as a blockchain.

In general, a blockchain means a generally distributed database whose integrity (security against subsequent manipulation) is safeguarded by storing the one-way function value, also called hash value, of the preceding data set or block or link in the one respectively succeeding that, that is to say by cryptographic linking. The protection arises owing to a majority of trustworthy nodes in a blockchain network, by which so-called mining or validating of blocks is carried out. In the network of the nodes participating in a blockchain, at regular intervals, for example every 10 minutes, a new block is formed and the hash value of an existing block is concomitantly stored in the process. Once transactions appear in the chain, they are no longer alterable without being noticed.

A connectivity of various devices in an industrial environment with the Internet can be referred to as the so-called IoT (Internet of Things), which is used as an umbrella term for a network of heterogeneous devices—e.g. IoT devices—which interact with one another and are communicatively connected to one another. In this regard, devices and systems which participate e.g. in industrial manufacturing processes or end products of such a production process can be connected to cloud platforms or the Internet or an IoT infrastructure, generally a communication network, and exchange data, e.g. in order to control a process, without human to human interaction or human to computer interaction being required.

An IoT network is a network of interconnected things or devices which are equipped with sensors, software, network connectivity and electronics which enable them to collect and exchange data. An IoT device can comprise an arbitrary device or system which is connectable to a network and which has sensor or control functionality. An IoT device can be connected to a local area network (LAN), a personal area network (PAN) and a wide area network (WAN). By way of example, an IoT device can contain one or more radio devices which operate with one or more communication protocols which enable the IoT device to connect to one or more LANs or PANs, such as e.g. WiFi, ZigBee, Bluetooth, Bluetooth Low Energy (BLE), Infrared Data Association, Transmission Control Protocol (TCP), User Datagram Protocol (UDP) and any other suitable protocol which enables a connection to a LAN.

A network, or network application, such as, for example, a P2P communication system, cloud, distributed ledger, blockchain, or a distributed database, allows the implementation of a distributed IoT ecosystem with various stakeholders who do not necessarily trust one another. Such a network application makes it possible to realize a P2P infrastructure with various stakeholders, where trust can be realized by technical measures even in a non-trustworthy environment.

The technology of blockchains or “distributed ledgers” is currently being intensively discussed and that can be realized in particular as a distributed database system or as a network application. Besides applications for decentralized payment systems (e.g. Bitcoin), new application possibilities are being developed in the financial industry. In particular, transactions between companies can be realized by this means without mediators or a clearing house, in a manner protected against manipulation. This enables new business models without a trustworthy mediator, for example a central entity, it reduces the transaction costs, and new digital services can be offered in a flexible manner, without the need to set up trust relationships and an infrastructure set up specifically for this. A transaction data set (or transaction for short) protected by a blockchain comprises program code, for example, which can also be referred to as a so-called “smart contract”.

Unless indicated otherwise in the following description, the terms “carry out”, “calculate”, “computer-aided”, “compute”, “establish”, “generate”, “configure”, “adapt” and the like relate to actions and/or processes and/or processing steps which change and/or generate data and/or convert data into other data, wherein the data can be represented or be present in particular as physical variables, for example as electrical pulses. In particular, the terms “computer”, node, or network node, or IoT device should be interpreted as broadly as possible to cover in particular all electronic devices having data processing properties. Computers can thus be for example personal computers, servers, programmable logic controllers (PLCs), handheld computer systems, pocket PC devices, IoT devices, mobile radio devices and other communication devices which can process data in a computer-aided manner, processors and other electronic devices for data processing.

In this disclosure, “computer-aided” means an implementation of the method in which in particular a processor performs at least one method step of the method.

In this disclosure, a “processor” includes a machine or an electronic circuit. A processor can be in particular a central processing unit (CPU), a microprocessor or a microcontroller, for example an application-specific integrated circuit or a digital signal processor, possibly in combination with a storage unit for storing program instructions, etc. A processor can for example also be an IC (Integrated Circuit), in particular an FPGA (Field Programmable Gate Array) or an ASIC (Application-Specific Integrated Circuit), or a DSP (Digital Signal Processor) or a graphic processing unit (GPU). Moreover, a processor can be understood to mean a virtualized processor, a virtual machine or a soft CPU. It can for example also be a programmable processor which is equipped with configuration steps for performing the stated method according to the invention or is configured with configuration steps in such a way that the programmable processor implements the features according to the invention of the method, of the component, of the modules, or of other aspects and/or partial aspects of the invention.

A memory, a “storage unit” or “storage module” and the like can be understood to mean for example a volatile memory in the form of main memory (Random-Access Memory, RAM) or a permanent memory such as a hard disk or a data carrier.

In this disclosure, a “module” means a processor and/or a storage unit for storing program instructions. By way of example, the processor is specifically designed to execute the program instructions in such a way that the processor executes functions of the corresponding module or for implementing or realizing the methods described herein or a step of the method. By way of example, a processor can be designed in such a way that it realizes the functions of a plurality of modules.

A module can also be a node of the distributed database system that realizes for example the specific functions/features of a corresponding module. The respective modules can for example also be embodied as separate or independent modules. For this purpose, the corresponding modules can comprise further elements, for example. These elements are for example one or more interfaces (e.g. database interfaces, communication interfaces—e.g. network interface, WLAN interface) and/or an evaluation unit (e.g. a processor) and/or a storage unit. By means of the interfaces, for example, data can be exchanged (e.g. received, communicated, transmitted or provided). By means of the evaluation unit, data can be compared, checked, processed, assigned or calculated for example in a computer-aided manner and/or in an automated manner. By means of the storage unit, data can be stored, retrieved or provided for example in a computer-aided manner and/or in an automated manner.

In this disclosure, “comprise”, in particular with regard to data and/or information, means for example (computer-aided) storage of corresponding information and/or of a corresponding datum in a data structure/data set (which e.g. is in turn stored in a storage unit).

In this disclosure, “assign”, in particular with regard to data and/or information, means for example a computer-aided assignment of data and/or information.

In this disclosure, “provide”, in particular with regard to data and/or information, means for example computer-aided providing. The providing is effected for example via an interface (e.g. a database interface, a network interface, an interface to a storage unit). Via said interface, for example, during providing, corresponding data and/or information can be communicated and/or transmitted and/or retrieved and/or received.

In this disclosure, “provide” means loading or storing, for example a transaction with corresponding data. This can be done for example on or by a storage module. “Providing” can for example also be understood to mean transferring (or transmitting or communicating) corresponding data from one node to another node of the blockchain or of the distributed database system (or the infrastructure thereof) or of the network application.

In this disclosure, a “checksum”, for example a data block checksum, a data checksum, a node checksum, a transaction checksum, a linking checksum or the like, means a cryptographic checksum or cryptographic hash or hash value that is formed or calculated in particular by means of a cryptographic hash function by way of a data set and/or data and/or one or more of the transactions and/or a partial area of a data block (e.g. the block header of a block of a blockchain or data block header of a data block of the distributed database system (or of the network application) or only a portion of the transactions of a data block). A checksum can be in particular (a) checksum(s) or hash value(s) of a hash tree (e.g. Merkle tree, Patricia tree). Furthermore, it can also be understood to mean in particular a digital signature or a cryptographic message authentication code. By means of the checksums, at different levels of the database system, for example, it is possible to realize cryptographic protection/protection against manipulation for the transactions and the data stored therein. If high security is required, for example, the checksums are generated and checked at the transaction level, for example. If the security required is not as high, the checksums are generated and checked for example at the block level (e.g. over the entire data block or only over a portion of the data block and/or a portion of the transactions).

In this disclosure, a “data block checksum” means a checksum that is calculated for example over a portion or all transactions of a data block. A node can then check/establish the integrity/authenticity of the corresponding portion of a data block by means of the data block checksum, for example. Additionally or alternatively, the data block checksum may in particular also have been formed over transactions of a preceding data block/predecessor data block of the data block. In this case, the data block checksum can in particular also be realized by means of a hash tree, for example a Merkle tree or a Patricia tree, wherein the data block checksum is in particular the root checksum of the Merkle tree or of a Patricia tree or of a binary hash tree. In particular, transactions are safeguarded by means of further checksums from the Merkle tree or Patricia tree (e.g. using the transaction checksums), wherein in particular the further checksums are leaves in the Merkle tree or Patricia tree. The data block checksum can thus safeguard the transactions for example by the root checksum being formed from the further checksums. The data block checksum can be calculated in particular for transactions of a specific data block of the data blocks. In particular, such a data block checksum can influence a data block succeeding the specific data block in order to link this succeeding data block for example with its preceding data blocks and in particular thus to make an integrity of the distributed database system (or of the network application) checkable. By this means, the data block checksum can for example perform the function of the linking checksum or influence the linking checksum. The header of a data block (e.g. of a new data block or of the data block for which the data block checksum was formed) can comprise the data block checksum, for example.

In this disclosure, “transaction checksum” means a checksum which is formed in particular over a transaction of a data block. In addition, for example a calculation of a data block checksum for a corresponding data block can be accelerated since, for this purpose, for example already calculated transaction checksums can be used straightaway as leaves of a Merkle tree, for example.

In this disclosure, a “linking checksum” means a checksum which indicates or references in particular a respective data block of the distributed database system (or of the network application) the preceding data block of the distributed database system (or of the network application) (often referred to as “previous block hash”, in particular, in the technical literature). For this purpose, a corresponding linking checksum is formed in particular for the corresponding preceding data block. As linking checksum, for example, a transaction checksum or the data block checksum of a data block (that is to say a present data block of the distributed database system or of the network application) can be used to link a new data block with a (present) data block of the distributed database system (or of the network application). However, it is also possible, for example, for a checksum to be formed over a header of the preceding data block or over the entire preceding data block and to be used as linking checksum. This can for example also be calculated for a plurality or all of the preceding data blocks. It is also possible to realize a procedure for example in which the linking checksum is formed over the header of a data block and the data block checksum. However, a respective data block of the distributed database system (or of the network application) may comprise in each case a linking checksum which was calculated, or refers to, a data block preceding the respective data block, in particular even more preferably the data block directly preceding the respective data block. It is also possible, for example, for a corresponding linking checksum also to be formed only over a portion of the corresponding data block (e.g. preceding data block). As a result, a data block comprising an integrity-protected portion and an unprotected portion can be realized, for example. A data block whose integrity-protected portion is invariable and whose unprotected portion can also still be changed later (in order e.g. still to store personal data in the unprotected portion) could thus be realized, for example. In this case, integrity-protected should be understood to mean in particular that an alteration of integrity-protected data is able to be established by means of a checksum.

The data which are stored in a transaction of a data block, for example, can be provided in particular in various ways. Instead of the data, e.g. user data such as measurement data or data/ownership concerning assets, for example a transaction of a data block can comprise only the checksum for these data. In this case, the corresponding checksum can be realized in various ways. This can be e.g. a corresponding data block checksum of a data block (with the corresponding data) of a different database or of the distributed database system (or of the network application), a transaction checksum of a data block with the corresponding data (of the distributed database system or of the network application or of a different database) or a data checksum that was formed over the data.

In addition, the corresponding transaction can also comprise a reference or an indication concerning a storage location (e.g. an address of a file server and indications of where the corresponding data may be found on the file server; or an address of a different distributed database or of a different network application comprising the data). The corresponding data could then for example also be provided in a further transaction of a further data block of the distributed database system or of the network application (e.g. if the corresponding data and the associated checksums are comprised in different data blocks). However, it is also conceivable, for example, for these data to be provided via a different communication channel (e.g. via a different database and/or a cryptographically secure communication channel).

Moreover, in addition to the checksum, for example, it is possible to store an additional data set (e.g. a reference or an indication concerning a storage location) in the corresponding transactions, which indicates in particular a storage location where the data can be retrieved. That is advantageous in particular so as to minimize a data size of the blockchain or of the distributed database system or of the network application.

In this disclosure, “linking (the) data blocks of a distributed database system or of a network application” means that data blocks each comprise information (e.g. a linking checksum) that refers to or references one other data block or a plurality of other data blocks of the distributed database system (or of the network application).

In this disclosure, “inserting into the distributed database system or the network application” and the like means for example that a transaction or the transactions or a data block with its transactions is/are communicated to one or more nodes of a distributed database system or of a network application. If these transactions are validated successfully (e.g. by the node(s)), for example, these transactions are linked in particular as a new data block with at least one present data block of the distributed database system or of the network application. For this purpose, the corresponding transactions are stored in a new data block, for example. In particular, this validating and/or linking can be effected by a trustworthy node (e.g. a mining node, a blockchain oracle or a blockchain platform). In particular, a blockchain platform means a blockchain as service, as proposed in particular by Microsoft or IBM. In particular, a trustworthy node and/or a node can in each case store a node checksum (e.g. a digital signature) in a data block (e.g. in the data block generated and validated by them, which is then linked) in order in particular to enable an identifiability of the creator of the data block and/or to enable an identifiability of the node. In this case, said node checksum indicates which node has linked for example the corresponding data block with at least one other data block of the distributed database system (or of the network application).

In this disclosure, “transaction” or “transactions” means for example a smart contract, a data structure or a transaction data set that comprises in particular in each case one of the transactions or a plurality of transactions. By way of example, a corresponding transaction can also comprise a smart contract. In this disclosure, “transaction” or “transactions” means the data of a transaction of a data block of a blockchain. A transaction can comprise in particular a program code that realizes a smart contract, for example.

By way of example, transaction can also mean a control transaction and/or a confirmation transaction with a confirmation message and/or an execution confirmation transaction with an execution confirmation message. An execution confirmation message can comprise for example a confirmation for an execution of the control commands of the control transaction by one of the devices if a corresponding device of the devices has successfully executed the control commands of the control transaction. For this purpose, the execution confirmation message can comprise for example a checksum generated by the corresponding device (e.g. a transaction checksum) over the executed control commands and/or can comprise a confirmation of the execution, which e.g. is likewise protected by the checksum.

An execution confirmation message can for example also be stored in the distributed database system or the network application if the device partly executes the control commands and/or the execution of the control commands is interrupted. This may be the case e.g. if a defect occurred at the device during the execution of the control commands, which defect no longer allows the execution of the control commands (e.g. a defect occurred at an actuator or tool). By way of example, a different device, which satisfies the execution requirements, or in other words the validation requirements, for the remaining unexecuted control commands, for example, can then execute these unexecuted control commands of the corresponding control transaction on the basis of the execution confirmation message. Accordingly, the execution confirmation message can comprise for example the degree of execution or an indication regarding the executed portion of the control commands.

In some embodiments, an execution confirmation message can indicate the control commands which still have to be executed for a successful execution of the control commands of a corresponding control transaction. Accordingly, by way of example, an execution confirmation message can comprise a data set indicating which of the control commands are still to be executed, or indicating which of the control commands are missing for the successful execution of the control commands for a corresponding control transaction. This makes it possible, for example, that further processing of the control commands can be effected even if the execution of the control commands was interrupted at a device. Accordingly, by way of example, the execution requirements can demand that more than one device (e.g. two or three devices or more devices) satisfies the execution requirements in order that an execution of the control commands is actually guaranteed, even if e.g. a device fails during the execution of the control commands of a corresponding control transaction.

In some embodiments, a transaction can be for example a data structure that stores data (e.g. the control commands). A transaction can for example also be referred to as a message (that is to say a communication message that stores data) or be a message that stores e.g. corresponding data (e.g. control commands). The teachings herein thus enable corresponding transactions or messages to be exchanged. In this case, transactions can comprise e.g. the control commands and/or contract data and/or other data such as video data, user data, measurement data, etc.

In particular, “storing transactions in data blocks”, “storing transactions” and the like include direct storing or indirect storing. In this case, direct storing means for example that the corresponding data block (of the distributed database system or of the network application) or the corresponding transaction (of the distributed database system or of the network application) comprises the respective data. In this case, indirect storing means for example that the corresponding data block or the corresponding transaction comprises a checksum and optionally an additional data set (e.g. a reference or an indication concerning a storage location) for corresponding data and, consequently, the corresponding data are not stored directly in the data block (or the transaction) (i.e. instead only a checksum for these data). In particular, when storing transactions in data blocks, it is possible to validate these checksums, for example, as explained for example under “inserting into the distributed database system or the network application”.

In this disclosure, a “program code” (e.g. a smart contract or chain code) means for example one program instruction or a plurality of program instructions, which are stored in particular in one or a plurality of transactions. The program code is executable, in particular, and is executed by the distributed database system or the network application, for example. This can be realized by means of an execution environment (e.g. of a virtual machine), for example, wherein the execution environment and respectively the program code are preferably Turing complete. The program code is preferably executed by the infrastructure of the distributed database system or of the network application. In this case, for example, a virtual machine is realized by the infrastructure of the distributed database system (or of the network application).

In this disclosure, a “smart contract” means for example an executable program code (see, in particular, the definition of “program code”). The smart contract may be stored in a transaction of a distributed database system or of the network application (e.g. a blockchain), for example in a data block of the distributed database system (or of the network application). By way of example, the smart contract can be executed in the same way as explained in the definition of “program code”, in particular in association with the invention.

In this disclosure, “smart contract process” can be understood to mean in particular execution of a program code (e.g. of the control commands) in a process by the distributed database system or by the network application, wherein for example the corresponding infrastructure of the distributed database system or of the network application executes the program code.

In this disclosure, “proof-of-work verification” means for example solving a computationally intensive task which is to be solved in particular depending on the data block content/content of a specific transaction. Such a computationally intensive task is for example also referred to as a cryptographic puzzle.

In this disclosure, a “network application” means for example a decentralized distributed database, a distributed database system, a distributed database, a peer-to-peer application, a distributed memory management system, a blockchain, a distributed ledger, a distributed storage system, a distributed ledger technology (DLT)-based system (DLTS), an audit-proof database system, a cloud, a cloud service, a blockchain in a cloud or a peer-to-peer database. By way of example, a network application can be a distributed database system that is realized e.g. by means of a blockchain or a distributed ledger. Moreover, it is possible to use, for example, various implementations of a blockchain or a DLTS, such as e.g. a blockchain or a DLTS implemented by means of a directed acyclic graph (DAG), a cryptographic puzzle, a Hashgraph or a combination of the implementation variants mentioned. Moreover, various consensus methods (referred to as consensus algorithms) can be implemented, for example. This can be for example a consensus method by means of a cryptographic puzzle, gossip about gossip, virtual voting or a combination of the methods mentioned (e.g. gossip about gossip combined with virtual voting). If a blockchain is used, for example, then this can be implemented in particular by means of a Bitcoin-based realization or an Ethereum-based realization.

A “distributed database system” or a “network application” can for example also be understood to mean a distributed database system or a network application of which at least some of its nodes and/or devices and/or infrastructure are realized by a cloud. By way of example, the corresponding components are realized as nodes/devices in the cloud (e.g. as a virtual node in a virtual machine). This can be effected for example by means of VM-Ware, Amazon Web Services or Microsoft Azure. On account of the high flexibility of the implementation variants explained, in particular partial aspects of the implementation variants mentioned can also be combined with one another, e.g. by using a Hashgraph as a blockchain, wherein the blockchain itself can e.g. also be blockless.

If for example a directed acyclic graph (DAG) is used (e.g. IOTA or Tangle), in particular transactions or blocks or nodes of the graph are connected to one another via directed edges. Acyclic here means, in particular, that there are no directed loops in the graph.

The distributed database system or the network application can be for example a public distributed database system or a public network application (e.g. a public blockchain) or a closed (or private) distributed database system or a closed network application (e.g. a private blockchain).

If a public distributed database system or a public network application is involved, for example, this means that new nodes and/or devices can join the distributed database system or the network application or be accepted thereby without authorization verifications or without authentication or without log-on information or without credentials. In particular, the operators of the nodes and/or devices can remain anonymous in such a case.

If the distributed database system or the network application is a closed distributed database system, for example, new nodes and/or devices require for example a valid authorization verification and/or valid authentication information and/or valid credentials and/or valid log-on information in order to be able to join the distributed database system or the network application or in order to be accepted thereby.

A distributed database system or the network application can also be for example a distributed communication system for data exchange. This can be for example a network or a peer-to-peer network.

A/The distributed database system can for example also be a decentralized distributed database system and/or a decentralized distributed communication system.

A “network” can for example also be a network application infrastructure or the network comprises a corresponding network application infrastructure. This infrastructure can comprise for example nodes and/or communication networks and/or data interfaces and/or further components in order to realize or implement the network application. The network application can be e.g. a distributed network application (e.g. a distributed peer-to-peer application or a distributed database system) which is implemented for example on a plurality of nodes of the network application infrastructure.

In this disclosure, a data unit or “data block”, which can also be referred to as “link” or “block” in particular depending on context and realization, means for example a data block of a distributed database system or of a network application (e.g. a blockchain or a peer-to-peer database), which in particular is realized as a data structure and preferably comprises in each case one of the transactions or a plurality of the transactions. In one implementation, for example, the database (or the database system) can be a DLT-based system (DLTS) or a blockchain and a data block can be a block of the blockchain or of the DLTS. A data block can comprise for example indications concerning the size (data size in bytes) of the data block, a data block header, a transaction counter and one or more transactions. The data block header can comprise for example a version, a linking checksum, a data block checksum, a time stamp, a proof-of-work verification and a nonce (one-off value, random value or counter used for the proof-of-work verification). A data block can for example also be only a specific storage area or address area of the entire data stored in the distributed database system or the network application. It is thus possible to realize for example blockless distributed database systems or network applications, such as e.g. the IoT chain (ITC), IOTA, and Byteball. In this case, in particular, the functionalities of the blocks of a blockchain and of the transactions are combined with one another in such a way that e.g. the transactions themselves safeguard the sequence or chain of transactions (of the distributed database system or of the network application) (that is to say, in particular, are stored in a security-protected manner). For this purpose, with a linking checksum, for example, the transactions themselves can be linked with one another, preferably by a separate checksum or the transaction checksum of one or more transactions serving as linking checksum, which is concomitantly stored in the corresponding new transaction when a new transaction is stored in the distributed database system or the network application. In such an embodiment, a data block can for example also comprise one or more transactions, wherein in the simplest case for example a data block corresponds to a transaction. By way of example, in addition to a checksum over the transactions, a checksum over the “state”, i.e. the states of the smart contracts and/or of the accounts and/or over the return values of the transactions (referred to as transaction receipts), can also be inserted e.g. into the transaction and/or the data block.

In this disclosure, “nonce” means for example a cryptographic nonce (abbreviation of: “used only once” or “number used once”). In particular, a nonce denotes an individual combination of numbers or letters that is preferably used once in the respective context (e.g. transaction, data transfer).

In this disclosure, “data blocks preceding a (specific) data block of the distributed database system or of the network application” means for example that data block of the distributed database system or of the network application which directly precedes in particular a (specific) data block. In some embodiments, “data blocks preceding a (specific) data block of the distributed database system or of the network application” can in particular also be understood to mean all data blocks of the distributed database system or of the network application which precede the specific data block. As a result, by way of example, the linking checksum or the transaction checksum can be formed in particular only over the data block (or the transactions thereof) directly preceding the specific data block or over all data blocks (or the transactions thereof) preceding the first data block.

In this disclosure, a “blockchain node”, network node, “node”, “node of a distributed database system of the network application” and the like mean for example devices (e.g. field devices, cellular phones), computers, smartphones, clients or subscribers that carry out operations with the distributed database system or the network application (e.g. a blockchain). Such devices can be connected to a component of a technical system. Such nodes can for example execute transactions of a distributed database system or of a network application or the data blocks thereof or introduce or link new data blocks with new transactions into the distributed database system or the network application by means of new data blocks. In particular, this validating and/or linking can be effected by a trustworthy node (e.g. a mining node) or exclusively by trustworthy nodes. A trustworthy node is for example a node that has additional security measures (e.g. firewalls, access restrictions to the node or the like) in order to prevent a manipulation of the node. In some embodiments, during the linking of a new data block with the distributed database system or the network application, a trustworthy node can store a node checksum (e.g. a digital signature or a certificate) in the new data block. The node checksum here can be for example a checksum e.g. of a data block or of a transaction, said checksum being signed by a corresponding node. A verification can thus be provided, in particular, which indicates that the corresponding data block was inserted by a specific node or indicates its origin. The devices (e.g. the corresponding device) are for example devices of a technical system and/or an industrial installation and/or an automation network and/or a manufacturing installation which in particular are also a node of the distributed database system or of the network application. In this case, the devices can be for example field devices or devices in the Internet of Things which in particular are also a node of the distributed database system or of the network application. Nodes can for example also comprise at least one processor in order to carry out e.g. their computer-implemented functionality.

In this disclosure, a “blockchain oracle” and the like mean for example nodes, devices or computers that have e.g. a security module comprising for example software protection mechanisms (e.g. cryptographic methods), mechanical protection devices (e.g. a lockable housing) or electrical protection devices (e.g. tamper protection or a protection system that erases the data of the security module in the event of impermissible use/handling of the blockchain oracle). In this case, the security module can comprise cryptographic keys, for example, which are necessary e.g. for the signature of the transaction and/or for calculating the checksums (e.g. transaction checksums or node checksums).

In this disclosure, a “computer” or a “device” mean for example a computer (system), a client, a smartphone, a server, each of which is arranged outside the blockchain or is not a subscriber of the distributed database system or of the network application (e.g. of the blockchain) (that is to say does not carry out operations with the distributed database system or the network application or only interrogates the latter, but without carrying out transactions, inserting data blocks or calculating proof-of-work verifications). In some embodiments, a computer can in particular also be understood to mean a node of the distributed database system or of the network application.

In other words, a device can be a node of the distributed database system or of the network application or else a device outside the blockchain or the distributed database system or the network application. A device outside the distributed database system or the network application can for example access the data (e.g. transactions or control transactions) of the distributed database system or of the network application and/or be driven by nodes (e.g. by means of a smart contract and/or blockchain oracle). If for example driving or control of a device (e.g. a device embodied as a node or a device outside the distributed database system or the network application) is realized by a node, this can be effected e.g. by means of a smart contract stored in particular in a transaction of the distributed database system or of the network application. A computer or a device can for example also be a part of the infrastructure which implements, realizes or comprises e.g. the network application or the distributed database system.

In this disclosure, “control commands” or “control transactions” mean for example a smart contract or executable program code which is executed in particular by the technical system, or the network application or the distributed database system or by corresponding devices, wherein for example the distributed database system or its nodes and infrastructure process or implement the corresponding control commands. In particular, a plurality of control commands or control transactions composed of one or more data blocks produce a command sequence. By means of the control commands, in particular a manufacturing installation with the associated manufacturing machines (e.g. devices) is controlled, the devices of an automation network are controlled or the devices of a power supply system are controlled or devices in the Internet of Things are controlled.

In some embodiments, the manufacturing instructions or manufacturing steps for a product and the production thereof are encoded in the control commands or control transactions (that is to say also in the command sequences). With the control commands or control transactions, devices are controlled, for example, by virtue of a device executing the corresponding control commands, for example. The devices (e.g. the corresponding device) are for example devices of a technical system and/or of an industrial installation and/or of an automation network and/or of a manufacturing installation and/or devices in the Internet of Things, which in particular are also a node of the distributed database system. In this case, the devices can be field devices, for example, which in particular are also a node of the distributed database system. The devices can also be automated teller machines, for example, wherein the control commands instigate a cash withdrawal. By way of example, the control commands can be derived from or determined from a command sequence. By way of example, a control transaction can comprise one or a plurality of control commands.

In some embodiments, the control commands encode mechanical movement and/or other physical variables (e.g. pressure or temperature), which are converted into the corresponding mechanical movement and/or the corresponding other physical variables by a corresponding device/node (e.g. by means of a corresponding actuator). By way of example, actuators of the devices and/or nodes are then controlled with the control commands. Accordingly, a corresponding device/node comprises an actuator, for example.

If a device/node is a robot, for example, then an actuator would also be referred to as an effector. A device can for example also be a mechatronic device or system, wherein a mechatronic device/system is for example an actuator and/or a linear-technological device. A linear-technological device is for example a device for carrying out translational movements. A corresponding device can for example also be a drive system. By means of the control commands and the devices and/or nodes, a control loop can for example also be controlled by closed-loop and/or open-loop control, for example by the execution confirmation messages for executed control commands being evaluated by the apparatus or by the network application and corresponding control commands being generated as a reaction to the execution confirmation messages. For these new control commands, then for example corresponding execution requirements are again determined or retrieved and they are then assigned again to control transactions, for example, in order that the latter are taken into account for example—as described in the invention—by the corresponding devices for the execution of the control commands. The control commands can for example also be control commands for controlling cryptographic devices and/or methods (e.g. a user authentication).

Control commands can for example mean command sequences or else transactions from a database or a database system or a network application which are intended to be executed by devices or nodes of the distributed database system or of the network application. A network application such as e.g. a database system can for example be the distributed database system if there are e.g. transactions to which execution requirements have not yet been allocated or assigned. Alternatively or additionally, the database system can be some other database, e.g. a conventional hierarchical database from which the corresponding transactions can be retrieved. Control commands can for example also be understood to mean command sequences or else transactions which are provided by an input system and which are intended to be executed by the distributed database system or the network application. Control commands can for example be understood to mean command sequences or control commands which are used to control mechanical and/or electrical and/or electromechanical and/or electronic devices.

In this disclosure, validation requirements, in other words execution requirements or requirements can be understood to mean for example properties which have to be complied with by a device for an execution of the control transaction or the control commands. By way of example, the validation requirements can comprise temporal requirements in respect of an execution of the transaction, for example the requirement in respect of a specific order of executing nodes, a requirement in respect of an interaction between two executing nodes, an interdependence between executing nodes, a specific point in time for completing the transaction, for example a specific time duration for carrying out the transaction. By way of example, the validation requirements can comprise device requirements. By means of the device requirements, there may be a specific predefined device, for example, which is intended to execute e.g. the control commands or the control transaction. In other words, predefinitions that have to be fulfilled by a device which is intended to execute the control commands are defined by the device requirements, for example. In this case, the device requirements are checked e.g. on the basis of device properties of a corresponding device.

The device requirements define, e.g. by means of a unique identifier, which devices can or are intended to carry out the predefined control actions (e.g. a manufacturing robot that can weld metal parts; a painting robot that can apply predefined paints to a manufacturing part; devices which produce electrical connections in an automated manner in a transformer substation). It is also possible to predefine e.g. a device which executes the manufacturing steps or control commands with a predefined precision and/or speed (e.g. lathes, milling machines and cutting machines).

In some embodiments, “device requirements” can also presuppose specific device classes which are predefined for execution or processing of the control commands. In particular, in this case, a device class is understood to mean one or a plurality of devices (e.g. grinding devices or sawing devices) which are able for example to perform specific predefined actions (e.g. grind or saw a specific material). In particular, the device requirements (which can also be referred to as device-specific requirements) are the requirements made of the corresponding devices and/or nodes for the purpose of executing the control commands. The device properties (which can also be referred to as device-specific data) then correspond for example to the actual and/or current device properties of a device. By way of example, a check is made to establish whether a device or a manufacturing machine is able to execute the control commands with the predefined precision which are predefined e.g. in the device-specific requirements. In particular, device-specific requirements can also be referred to as mechanical and/or mechatronic and/or manufacturing-specific requirements.

In some embodiments, device-specific data or device properties can also be referred to as mechanical and/or mechatronic and/or manufacturing-specific data or device properties. In particular, device-specific data or device properties can also be referred to as device information. In particular, the device requirements predefine the requirements which are intended to be satisfied by the device-specific data of a device. In other words, the device requirements predefine a “target” value, which is compared with the “actual” value on the part of the devices. In this case, the device-specific data constitute in particular the current device properties. These device properties or device-specific data comprise for example the UID of a device or of a system, available tools or supported manufacturing methods (milling, grinding or 3D printing), manufacturing precision, manufacturing costs, location of the devices, network address for addressing/driving the device, authorized users etc.

The validation requirements can for example also be or comprise security requirements or location-related requirements (e.g. a country indication, a GPS indication or postal code (ZIP code)) which are intended to be satisfied by a device for the execution of the control commands. By way of example, it may be demanded that the device ought to have predefined security facilities or that a specific or a predefined authentication also be required for the execution of the control commands at the device. This may be the case, for example, if someone would like to withdraw cash at a device (e.g. an automatic teller machine). The control commands are then for example the customer requirement to effect a cash withdrawal.

By way of example, if a corresponding customer has configured the fact that this customer allows a cash withdrawal e.g. only in predefined countries, e.g. Italy, France and Austria, then this is stored in the device-specific requirements (and in particular optionally likewise implicitly in the execution requirements). An automatic teller machine in Andorra, if appropriate, would then not allow a withdrawal or would prevent it. In some embodiments, this can e.g. also be prevented by a different node of the distributed database system or be prevented by a smart contract of the distributed database system. Moreover, a specific authentication of the customer may be demanded by the security requirements, for example. By way of example, a PIN is entered for a withdrawal (which is not necessarily the case e.g. in the USA) and/or a specific PIN length is demanded (e.g. eight characters) and/or other additional authentication procedures are demanded (e.g. two-factor authentication, mobile TAN, Google Authenticator).

In some embodiments, the determining module can also analyze the control commands further and, if for example the determining module already ascertains that the device requirements are not satisfied or are not able to be satisfied, can create a control transaction which points this out to the corresponding device or the system or the network application and, if appropriate, prevents an execution of the control commands. In some embodiments, for example, it is also possible not to generate a control transaction and sometime there is a timeout for the execution of the control commands, e.g. after a predefined time period, which is preferably configurable.

In this disclosure, “system-specific data” or “device-specific data” or “device properties” can for example also be understood to mean system properties or device properties of a device or of a technical system. The device-specific data or system-specific data or device properties are for example current device properties or system properties. The device-specific data or system-specific data (or the corresponding properties) can comprise the following data for example for a technical system, the devices of a technical system or a device: the UID of the device or of the system, available tools or supported manufacturing methods (milling, grinding or 3D printing) of the device or of the system, manufacturing precision of the device or of the system, manufacturing costs of the device or of the system, location of the device or of the system, network address for addressing/driving the device or the system, authorized users for the device or the system, name of the device or of the system, etc.

Depending on the chosen implementation, for example, the system-specific data can be realized overall for one device or a plurality of devices of a technical system, by virtue of the fact that e.g. by means of a UID/(network) address of the technical system, it is also possible to address, identify or communicate with the corresponding devices of the technical system. In some embodiments, for example the device-specific data for said one device or the plurality of devices of the technical system can be included in the system-specific data.

In this disclosure, a “technical system” can for example be understood to mean one device or a plurality of devices which are communicatively connected to one another and/or to a distributed database system (e.g. the first distributed database system) and/or to the network application, for example a mechanical installation or a production installation.

In this disclosure, “presupposed control commands” can for example be understood to mean control commands which already have to be executed in particular by other nodes (of the distributed database system) and/or by one or more of the devices before the corresponding control commands can be executed. In particular, for these pre-executed control commands corresponding execution confirmation messages are stored in the distributed database system or the network application (e.g. in data blocks of the distributed database system) if e.g. the pre-executed control commands were successfully executed by devices or nodes. In particular, in the case of these pre-executed or presupposed control commands, the device requirements assigned to these pre-executed control commands are also concomitantly checked or concomitantly taken into account.

By means of the execution requirements, it is ensured in particular that for example an order of the manufacturing steps when creating a product is complied with. What is thus achieved, for example, is that the manufacturing order is complied with in an expedient manner. This prevents e.g. one manufacturing step from being ruined by another merely because the manufacturing order was not complied with. In a similar manner, in particular it is also possible to control a controller of a power supply system by e.g. transformers or voltage couplers being switched on or connected to the power supply system in the correct order. If no presupposed control commands are required for the execution of control commands or control transactions, for example, the presupposed control commands can be blank. By way of example, the latter can be occupied by a zero, or occupied by an empty string or a value indicating that no presupposed control commands are necessary.

In some embodiments, it is possible for example for no execution requirement to be assigned to a portion of the control commands, wherein in particular at least one execution requirement is assigned to at least one of the control commands. By way of example, the presupposed control commands are control commands which e.g. were converted into a predefined mechanical movement and/or other physical variables (e.g. pressure or temperature) by a device and/or node or are intended to be converted before the processing of the control commands (e.g. for preparation of a workpiece). With the presupposed control commands (provided that the latter were executed successfully), for example, the actuators of the devices and/or of the nodes were then driven in such a way that a workpiece was brought to the state or manufacturing state where e.g. further processing is possible or is made possible after the processing of the presupposed control commands.

Accordingly, e.g. the corresponding devices/nodes can then be driven with the control commands of the control transaction in such a way that the further processing is effected (when e.g. the presupposed control commands were executed and in particular execution confirmation messages are present for them). By means of the presupposed control commands and the devices and/or nodes, a control loop can for example also be controlled by closed-loop and/or open-loop control, for example by the execution confirmation messages for executed/presupposed control commands being evaluated by the apparatus or by the network application and corresponding control commands being generated as a reaction to the execution confirmation messages. The presupposed control commands can for example also be control commands used to drive a cryptographic device and/or method (e.g. a user authentication).

In some embodiments, for example a detection of specific measurement variables (e.g. by a sensor) can be predefined by the presupposed control commands. By way of example, it is thus predefined that corresponding transactions with corresponding measurement values are intended to comply with predefined measurement value ranges or threshold values. The measurement values can be for example a value of a measured variable (e.g. 30° C.) and/or date/time of day of the detection and/or location of the detection and/or sensor type and/or further information about the sensor (e.g. measurement accuracy).

In this disclosure, a “separate and/or direct communication channel” can for example be understood to mean data transfer (e.g. transmitting, receiving, transferring, providing or communicating) by means of a communication channel such as is realized for example by the Lightning network initially only for the transfer of cryptocurrency. By way of example, via this channel, it is possible to send transactions/messages more rapidly and to store a confirmation about this data exchange in the distributed database system or the network application. Thus, for example, important and/or time-critical control commands or control transactions can be transferred at higher speed to a corresponding device and e.g. the slower data transfer of the distributed database system (e.g. in the case of the replication of the data blocks/transactions) or of the network application can be avoided in the process. By way of example, for the invention and the stated aspects, exemplary embodiments, embodiments of the invention and their variants, a separate and/or direct communication channel can be established for a data transfer between a device (and/or node).

By way of example, in the case of a direct communication channel, the transactions/messages are exchanged directly between a transmitter (e.g. the providing module and/or the determining module) and a receiver (e.g. the device that is intended to execute the control commands), without further nodes and/or devices of the distributed database system or of the network application being involved in this data exchange. By contrast, in the case of a separate communication channel, nodes and/or devices of the distributed database system or of the network application can be involved in the data exchange. If the separate and/or direct communication channel was successfully established between the transmitter and the receiver (that is to say that in particular a communication connection was established as a result), then data for example in the form of transactions or messages can be exchanged between the transmitter and the receiver.

By way of example, the necessary data for ascertaining the executability and/or the control transactions can be exchanged between the transmitter and the receiver. If for example the communication channel is closed/ended (that is to say that in particular a communication connection is ended), then for example a result of the data transfer e.g. in the form of transactions (e.g. as a transfer confirmation transaction) is stored in the distributed database system (e.g. in data blocks of the distributed database system) or is stored in the network application. The result of the data transfer can be for example a confirmation of the transfer or of the reception of the corresponding transactions/messages and/or an analysis result and/or the last transferred transaction/message that was transferred via the separate and/or direct communication channel before the communication channel was closed.

The storage of the transaction with the result can be effected by the transmitter and/or receiver, for example. The analysis result can be for example the confirmation of the executability of the control commands by a device, wherein for example a corresponding device has confirmed that it can execute the control commands. This can for example in turn be stored in a transaction (e.g. in an executability confirmation transaction or in a confirmation message) and be stored e.g. in the execution requirements (e.g. in the device-specific requirements).

In some embodiments, an executability confirmation transaction is stored in the distributed database system or the network application. In this case, the executability confirmation transaction comprises for example a unique identifier for the device that is able to execute the control commands or satisfies the corresponding execution requirements.

In some embodiments, the executability confirmation transaction comprises for example data regarding the execution, e.g. how well or to what degree the execution requirements are satisfied (e.g. how rapidly the control commands are processed, when the latter are securely processed, how accurately or precisely the control commands are executed—for example when executing manufacturing control commands). In some embodiments, the executability confirmation transaction comprises for example device-specific data of the corresponding device which are relevant to the execution of the control commands, wherein e.g. the device-specific data were ascertained by the corresponding device at the time of the confirmation of the executability by the device. In this case, e.g. the confirmation of the executability and the ascertainment of the device-specific data are effected (approximately) at the same time—for example within a time window of a few seconds or minutes.

By way of example, the data of the executability confirmation transaction may also have been exchanged between the transmitter and the receiver before the executability confirmation transaction is stored e.g. in the distributed database system or the network application. The executability confirmation transaction can for example also be cryptographically protected (e.g. it can be encrypted or be protected by a transaction checksum). Moreover, for example the control transactions can be transferred in an analogous manner to the corresponding device which is intended to or can execute the control commands. For this purpose, for example, a further separate and/or direct communication channel can be established between the transmitter and the receiver.

In some embodiments, the communication channel mentioned above can continue to be used, for example. Via the corresponding communication channel, for example the corresponding control transactions are then transferred to the corresponding device. If for example the communication channel is closed/ended again if the transfer has been concluded (successfully), the result of the transfer e.g. as a transfer confirmation transaction is stored in the distributed database system or the network application. Moreover, for example, the last message exchanged via the communication channel can be stored in the transfer confirmation transaction (e.g. if the communication channel is interrupted) and the transfer confirmation transaction can e.g. then be stored in the distributed database system or in the network application. Said last message exchanged can be used for example to continue the data exchange or the data transfer in the event of renewed establishment of the communication channel.

The transfer confirmation transaction can for example also be cryptographically protected. The transfer confirmation transaction can comprise for example the control commands and/or the control transaction and/or the last message exchanged between the transmitter and the receiver. A continuation of the data exchange or of the data transfer can for example also be used for other data transfers and is not specifically restricted to the data transfer or the data exchange of control transactions.

The separate and/or direct communication channel may improve a transfer speed and/or transfer latency. A hybrid method is also possible, for example, where for example a corresponding communication channel is used for time-critical control commands (e.g. with high priority). By way of example, on the basis of the execution requirements (e.g. there are time-critical control commands or control commands for a real-time application) it is possible to determine whether the control commands are corresponding control commands which are intended to be transferred via a corresponding separate communication channel.

In some embodiments, the determining module, for example, when determining the execution requirements, can determine corresponding transfer requirements for a data transfer of the control transactions. The transfer requirements can be stored in the execution requirements, for example. On the basis of the transfer requirements, for example the providing module can then ascertain whether the control transactions are stored in the distributed database system or the network application by way of a transfer to the corresponding device or whether the separate and/or direct communication channel is used for a data transfer to the corresponding device. The data transfer can then be effected by the providing module of the apparatus, for example, said providing module comprising for this purpose e.g. a corresponding communication module (e.g. a network interface).

Some embodiments use for example a blockchain, a network application or a distributed database system e.g. as an industrial communication infrastructure and/or control platform e.g. in the manufacturing sector. It is thereby possible to realize in particular a manufacturing infrastructure in which devices (e.g. autonomous devices) of different operators in a trustless environment require a trust basis in order to process a manufacturing job (Trust in a trustless environment). In this case, for example temporal requirements can be predefined e.g. by the configurability and the selectability of the validation and/or transfer. The distributed database system validates e.g. only those transactions which can be executed by a corresponding blockchain-based manufacturing system or the corresponding devices, by virtue of e.g. a predefined number of nodes confirming that they execute these transactions.

By way of example, it is also possible for the predefined number of nodes to be at least partly or completely nodes of a shard (e.g. of an Ethereum shard). In some embodiments, it is also possible for the predefined number of nodes to be at least partly nodes of different shards. The respective shards of a network application (e.g. of a distributed database system such as a blockchain) can be formed specifically for nodes in the form of devices, by virtue of e.g. the nodes of a shard being formed by the device properties (e.g. manufacturing device, test device, secure device or device with high reliability or manufacturing precision).

The methods described herein may be suitable in particular for IoT applications of the blockchain where e.g. at least one device is intended to execute any control action, the execution being subject to certain execution requirements. Conventional blockchains can be improved e.g. to the effect of improving the executability of transactions or preventing non-executable transactions from being stored in the blockchain. This is particularly if the control transactions or the control commands encode or comprise a smart contract, since there is e.g. a need for storing preferably executable smart contracts in a blockchain.

The networking of edge devices and IoT devices is an important aspect in the digital industrial sphere. In particular, forming ecosystems in which these corresponding devices or a multiplicity of such devices communicate with one another in order to control processes is a challenge. Communication in systems with different device manufacturers or device owners who do not necessarily trust one another is a particular challenge here. For a few years, communication infrastructures (also called IoT infrastructures) have been available which allow trustworthy communication between such devices even in an environment classified as not trustworthy, and possibly without a central third party building up trust. Distributed ledger technologies (DLT) are an example of such a technology.

What is problematic here is that when a process (e.g. a manufacturing process, a control process of a complex (town/city) infrastructure) is processed by a multiplicity of different IoT devices in a heterogeneous IoT network, it is unclear whether and how this process can be executed by the technical system or whether optimizations are necessary for its execution. Particularly in a semi-automated or fully automated IoT control infrastructure with various stakeholders in which parts of the processes have to be adapted dynamically during execution of the process, the execution of the process may be interrupted or even terminated.

In conventional solutions, a technician monitors the execution of the process on site and intervenes manually, if appropriate. The techniques disclosed herein solve the problem that in an industrial application of a blockchain or of a distributed database system, the transactions which are intended to be validated and included in the blockchain are only those transactions whose executability has either been confirmed by means of a digital twin-based simulation of the process or of the application, said simulation optionally being certified for example by the system participants or some other mechanism, or whose executability was able to be established by an optimization or reconfiguration of the control commands and of the associated transactions. For this purpose, nodes of the network which can put blocks and transactions into the blockchain comprise an interface to a digital twin of the blockchain or IoT infrastructure.

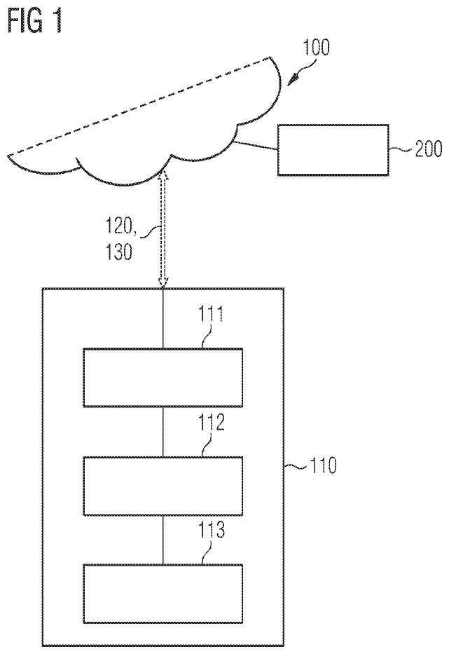

FIG. 1 schematically shows an example network node 110 incorporating teachings of the present disclosure. The network node 110 comprises an interface 111, a processor 112 and a memory 113. The network node is communicatively connected to the network 100 via the interface 111, wherein via the interface the node can receive transactions 120 and validation requirements 130 from the network 100, and can communicate transactions 120 and validation requirements 130 to the network 100 and/or the digital simulation 200 of a technical system. The digital simulation 200 is designed as a network node in the network 100 in FIG. 1.

FIG. 2 schematically shows an example network 100 incorporating teachings of the present disclosure. The network 100 in FIG. 2 can be an IoT infrastructure in which a multiplicity of nodes 110 are communicatively connected to one another in a decentralized network. As shown in FIG. 2, the network nodes 110 are situated in a P2P network without a central entity, wherein the nodes 110 can jointly realize a distributed database, for example. For control purposes, each of the nodes 110 can be connected to a component of a technical system, or comprise said component. In other words, the IoT infrastructure comprises both a technical system and network nodes of a communication network and/or a database. Via the network, it is possible to exchange and store control commands, sensor data, or generally transactions which arise upon the execution of a process on the technical system.

By way of example, the IoT infrastructure 100 in FIG. 2 is intended to carry out the following transactions:

transaction A: control commands for driving a conveyor belt for transporting a workpiece;
transaction B: control commands for drilling holes on the underside of the workpiece;
transaction C: control commands for drilling holes on the top side of the workpiece;
transaction D: control commands for grinding the workpiece; and
transaction E: control commands for painting the workpiece.

In one step, the transactions A-E 120 are communicated to a node 110 or IoT device. The node 110 receives the transactions A to E which are intended to be executed by the technical system.

In one step, validation requirements 130 are determined for the corresponding transactions 120 or said validation requirements 130 accompany the corresponding transactions 120. Said validation requirements 130 can be ascertained separately or with the aid of a digital simulation of the technical system, the so-called digital twin. For industrial applications, the validation requirements can stipulate e.g. what minimum number of nodes can execute the transactions, what device prerequisites (location, precision during execution, safety equipment) are able to be satisfied by the nodes, within what period of time the transaction is intended to be executed, or a price range for the payment for the execution of the transaction.

In this case, the transactions comprise for example control commands for controlling or processing a manufacturing process for a workpiece. The validation requirements can e.g. stipulate that the workpiece is intended to be manufactured in 2 hours.

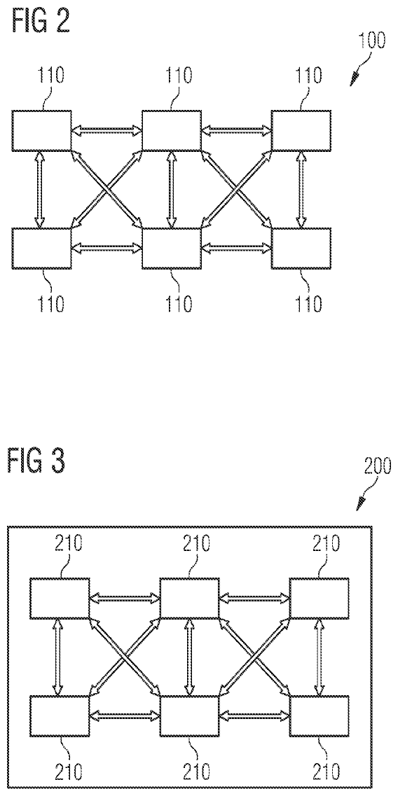

FIG. 3 schematically shows a digital simulation 200 of the IoT infrastructure 100 from FIG. 2. As can be seen in FIG. 3, the digital simulation 200 constitutes an identical copy of the technical system and/or the control network 100. Each digital node 210 in the digital simulation 200 corresponds to a node 110 of the real network 100. In the digital simulation, the control commands contained in the transactions can thus be executed in a simulated manner in the same way as by the real system 100. In particular, for example, capacity utilizations of individual nodes 210, the temporal sequence of process steps between nodes 210, dependencies between the nodes 210, and also boundary conditions of the technical system such as sensor values, for example, can be simulated.

Under these prerequisites, the node 110 which receives the transactions 120 for validation drives the corresponding digital twin 200. By way of example, the simulation of this manufacturing process may reveal that such a workpiece cannot be manufactured in 2 hours in the original order of the transactions A-E. In such a case, the node would not validate the transactions A-E and would not add them to the blockchain.

In this case, it is advantageous that data which cannot be processed by IoT devices/nodes 110 are prevented from being put into the industrial blockchain.

By means of the simulation by the digital twin 200, the transactions or control commands can also be optimized, however, such that these transactions which initially were not executable are made executable again. This involves establishing that the transactions B and C can be processed in one step by an IoT machine tool by virtue of the holes being drilled at the top and bottom simultaneously or on the same device. Furthermore, it is also possible, however, to establish which steps/series are not permitted to be changed. By way of example, grinding and painting must take place after drilling. Moreover, it is absolutely necessary for painting to take place after grinding.

If it was possible to establish that the adapted or optimized transactions 120 or the process can be processed by the combined IoT blockchain network, then e.g. the control commands or transactions 120 can be reorganized before they are put into the blockchain as validated transactions 120. This ensures that only actually executable control transactions are put into the blockchain.

If the transactions 120 have been put into the blockchain and they are processed, e.g. transaction A, a confirmation transaction is put into the blockchain after the processing of said transactions. This signals that transaction B/C can be processed by the next IoT manufacturing node 110.

In some embodiments, the information obtained by the simulation can be used to transfer the corresponding control transactions A-D to corresponding IoT blockchain nodes in an accelerated manner (e.g. using the Lightning network or a similar protocol: https://de.wikipedia.org/wiki/Lightning-Netzwerk), or the processing of the next transaction 120 can be initiated after the processing of a transaction by means of such an approach. In such a case, the corresponding IoT devices would communicate directly with one another by using the information from the simulation (e.g. what device can process what control commands). The IoT devices then store the corresponding information about the processing and the confirmation thereof in the blockchain (see Lightning network). It is also possible to implement a mixture of such a processing system since there are e.g. control transactions which must be processed successively as rapid as possible (e.g. the workpiece is not permitted to cool down too much).

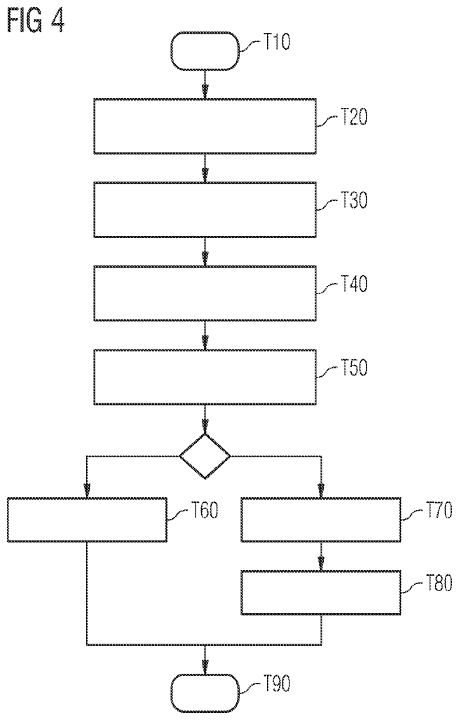

FIG. 4 shows a flow diagram of a method for operating a network node 100 incorporating teachings of the present disclosure. The method begins in step T10.

In step T20, a transaction containing control commands which are intended to be executed by the technical system is received by a node. In step T30, a validation requirement is determined for the transaction. In step T40, the transaction and the determined validation requirement for the transaction are transferred to a digital simulation of the network.

In step T50, the transaction is executed in the digital simulation in order to establish whether the transaction can be executed according to the validation requirement. If the transaction can be executed in the digital simulation in such a way that the validation requirement is satisfied, then in step T60, in the network, the transaction is validated for execution by the technical system; by way of example, the transaction is stored in a distributed database of the network for execution.

If the digital simulation establishes that the transaction cannot be executed according to the validation requirement, then step T70 involves checking whether executability of the transaction can be established by a reconfiguration of the control commands in the transaction, and afterward, in step T80, the reconfigured control commands are stored as a new transaction in the network. The method ends in step T90.

In general, various embodiments of the present disclosure provide a multiplicity of circuits, data memories, interfaces or electrical processing devices, e.g. processors. All references to these units and other electrical devices and also the functions provided by them are not restricted to what is illustrated and described. While the various circuits or other electrical devices disclosed can be assigned specific designations, these designations are not intended to restrict the functional scope of the circuits and the other electrical devices. These circuits and other electrical devices can be combined with one another and/or separated from one another depending on the desired type of electrical implementation.

It should be understood that every disclosed circuit or other electrical device can comprise an arbitrary number of micro-controllers, graphic processing units (GPUs), integrated circuits, storage devices, e.g. FLASH, random-access memory (RAM), read-only memory (ROM), electrically programmable read-only memory (EPROM), electrically erasable programmable read-only memory (EEPROM), or any other suitable embodiments of same, and also software, which cooperate with one another in order to carry out the method steps disclosed herein. Furthermore, each of the electrical devices can be configured to execute program code which is contained in an electronically readable data carrier and which is configured to perform an arbitrary number of steps in accordance with the methods of the present disclosure.

Some general conclusions can be drawn from the statements above:

If a transaction cannot be executed according to a validation requirement, the node can be further configured for adapting the control commands using the digital simulation in order to find adapted control commands. In this case, the node can adapt for example one or more parameters provided by the simulation. In other words, adapting the control commands can be based on the results of the digital simulation. By way of example, the node can adapt a parameter in the control commands, for example an order in the processing of the control commands, on the basis of the validation requirement.

The node can be further configured to initiate execution of the changed control commands by the digital simulation in order to establish whether the adapted control commands can be executed according to the validation requirement.

If it is established that the adapted control commands can be executed by the technical system, the node can be configured to validate the adapted control commands as a new transaction for execution by the technical system.

It is thus possible to ensure that exclusively a transaction whose executability has been confirmed by a simulation of the contained control commands in the digital simulation is validated for execution by the technical system.

The digital simulation can be a digital twin of the technical system and/or of the control network.

The network can be a network application (or the infrastructure of the network application) such as a distributed database, in particular a database based on a distributed ledger technology (DLT). Validating a transaction for execution by the technical system can comprise storing the transaction by means of a distributed database or network application which is formed by a multiplicity of IoT devices of the technical system. In this case, the technical system together with the network (100) for controlling the technical system can be an Internet of Things (IoT) system. The node can be designed to store the transaction as a data block in a blockchain.

If it was established that the transaction can be executed by the technical system according to the validation requirement, the node can forward the transaction, on the basis of the successful simulation by the digital simulation, to one or more nodes intended to execute the transaction. In particular, the forwarding can be carried out by a transfer mechanism which is independent of a complete data replication in the network. A transfer mechanism comprising a Lightning protocol can be used in this case.

By means of a comparison in the simulated execution of the transaction with a subsequent real execution of the transaction by the technical system, a quality of the validation of a node of the digital simulation can be determined. The quality of the validation of the node can be used during a validation of a further transaction in order to determine a dynamic weighting factor of the node relative to other nodes of the digital simulation.

A transaction can be validated if a predetermined number of nodes of the digital simulation confirm that the transaction can be executed according to the validation requirement. Here a node can also be assigned a weighting factor which assigns to the confirmation of the node a higher or lower relevance relative to relevances of confirmations of other nodes. A transaction can thus also be validated if it attains a predetermined relevance in total.

It should be understood that the techniques disclosed can be applied to a multiplicity of transactions. A node receives a multiplicity of transactions. The transactions each comprise control commands which are intended to be executed by a corresponding node of the technical system. An associated validation requirement is determined for each transaction. The transactions and the associated validation requirements are transferred to a digital simulation of the technical system by the node. The transactions are executed in the digital simulation in order to establish whether they can be executed according to the associated validation requirements. If it is established that a predefined minimum number of nodes of the digital simulation can execute the corresponding transactions according to the associated validation requirements, then the node can validate all transactions for execution by the technical system.

The method can be realized in a computer-aided manner, i.e. in a computer-implemented manner. The techniques disclosed are suitable in particular for the control of processes in an Internet of Things (IoT) infrastructure or an IoT system in which at least one IoT device is intended to execute a control action by means of control commands, the execution being subject to certain requirements which can be represented by validation requirements. In an industrial environment, a technical system can be controlled by an IoT control network. A technical system can comprise various components (devices/machines/installation parts) of a mechanical installation, which cooperate in order to execute a process. A component can comprise for example a controller, one or more sensors, a network interface, a processor and a memory, which represent a node of the control network.

An IoT system or network application or a network structure can serve as a control system for controlling execution of transactions by the technical system, and can be realized as a distributed database, a DLT database, and/or a blockchain, or a combination of the possibilities mentioned.

Validation requirements can be predefined by a transaction, or be calculated. By way of example, validation requirements can be integrally integrated in a blockchain (e.g. in the genesis block).

Minimum requirements/validation requirements can be ascertained by an analysis of the transaction by the node.

Such ascertaining can be based on or ascertained using one or more of the following aspects, for example:
priority of the control commands
required maximum execution time
execution costs
payment of fees
execution timeframe
precision of the execution
requirement in respect of component interaction and system feedback

When confirming the executability, the simulation can for example take account of the following aspects or use the results of the following checks:
nodes check their own system state (e.g. if maintenance is imminent if tools are worn, the required manufacturing precision can be complied with)
nodes check the system state of other relevant systems for example by way of specific requests
nodes check their backlog, which still needs to be executed
nodes check their own or otherwise accessible data histories (referred to as historians) in order to make a derived prediction of the execution results for a transaction e.g. using machine learning. In this case, a node can apply functions trained (end-to-end trained) with training data to one or more data histories, whereby a prediction of the execution results is output as direct output.

For this purpose, the corresponding nodes can comprise an interface in order that the corresponding information is made available to the digital twin node in as up to date a way as possible. The simulation can thus be executed as exactly as possible.

Dependent transactions can be regarded e.g. as an overall transaction (the entire process which is intended to be executed) which is validated (in order to validate the overall transaction, the corresponding individual transactions must likewise be validated).

During the execution of the transactions by the nodes, the following aspects can be taken into account e.g. in the simulation:

An order for the execution nodes is defined on the basis of the confirmation order (e.g. according to time, availability, etc.).

If the first node does not execute the transaction within a predefined period of time (e.g. predefined in the validation requirements): communication to the next node.

The period of time can also be calculated on the basis of the validation requirements (e.g. target transaction must be executed within 8 h, 4 nodes have declared themselves ready to execute the transaction, and if the first node does not communicate a confirmation for the execution after 2 h, the second node is interrogated).

The period of time can take account of diverse further aspects: transportation delay for messages via the network (this is measured), processing time due to nodes.

A digital twin can constitute a digital representation of a real infrastructure or of a real process. Digital twins enable data exchange with the real counterpart. They consist of models of the represented object or process and can comprise simulations which describe and/or influence properties or behaviors of the represented object or process.

In association with the invention, “digital twin” can be understood to mean for example a digital mapping, in particular in the form of a data model or of a data structure, of a real industrial installation or of a manufacturing process onto an industrial installation. In particular, the term digital twin is also explained in the following patent applications: WO2016/141998 or PCT/EP2016/064785. In particular, a digital twin can be updated on the basis of data of the object that is represented. These corresponding data can for example be acquired by sensors and then update the digital twin. This can be done for example in real time, periodically, under manual control or at predefined points in time. A primary digital twin can be understood to mean for example a digital simulation of a technical system which comprises in particular a large amount of data and comprises for example hundreds or thousands of data sets. All functions and devices of a technical system and of the control network of the technical system can be represented identically in the digital simulation.

A digital twin can be implemented in various ways without limitations as long as the relevant requirements regarding executability are taken into account. The digital twin can be realized for example as a simulation created purely analytically e.g. using probabilistic methods, it can contain hardware in the loop components, it can be based purely on machine learning methods, but also any combinations.

In a further implementation of the system, by means of the comparison of the transactions validated by the digital twins with the real execution of the process steps, the validity or the quality of the validation of the individual digital twin nodes can also be ascertained. This can in turn be used for a dynamic weighting of the approval of a digital twin node by means of weighting factors in the validation of a new transaction in the sense of a degree of “contravention of contract”.

IoT devices can be designed as nodes of a distributed database system and, for executing or processing the control commands, for example, a corresponding node or a corresponding device which satisfies the demanded validation requirements for executing the control commands can be found dynamically.

In some embodiments, techniques inter alia for the control of processes in an IoT infrastructure are provided which make it possible to use a blockchain for industrial application primarily in the field of manufacturing. In this case, temporal requirements can be predefined, for example, by virtue of the configurability and the selectability of the validation and/or transfer. The distributed database system validates only those transactions which can be executed by a corresponding blockchain-based manufacturing system by virtue of the fact that a predefined number of nodes confirm that these execute the transactions. This ensures that only executable or potentially executable transactions become part of the blockchain. This is important in particular if such a system is realized as an open ecosystem in which the validation of possible transactions is not realized by a third party.

As a result, it is possible, in particular, to realize a decentralized infrastructure for executing control commands, control of a technical system in the Internet of Things being carried out in a decentralized manner, even if individual operators of devices and/or device groups of the devices do not trust one another.

Although the teachings herein have been shown and described with regard to specific exemplary embodiments, equivalents and modifications will be implemented by those skilled in the art after reading and understanding the description. The scope of the present disclosure encompasses all such equivalents and modifications.

What is claimed is:

1. A node of a network for controlling a technical system, the node programmed to:
acquire a transaction comprising control commands to be executed by the technical system;
determine a validation requirement for the transaction;
transfer the transaction and the validation requirement to a digital simulation of the technical system; and
execute the control commands using the digital simulation to establish whether the transaction can be executed according to the validation requirement.

2. The node as claimed in claim 1, further programmed to, if it was established that the transaction can be executed according to the validation requirement,
validate the transaction (120) for execution by the technical system, in particular storing the transaction (120) in the network (100).

3. The node as claimed in claim 1, further programmed to, if it was established that the transaction cannot be executed according to the validation requirement:
adapt the control commands using the digital simulation to find adapted control commands;
execute the adapted control commands using the digital simulation to establish whether the adapted control commands can be executed according to the validation requirement; and
if it is established that the adapted control commands can be executed by the technical system, validate the adapted control commands as new transaction for execution by the technical system.

4. The node as claimed in claim 1, wherein exclusively a transaction whose executability was confirmed by transferring to the digital simulation and simulating the control commands in the digital simulation is validated for execution by the technical system.

5. The node as claimed in claim 1, wherein the digital simulation comprises a digital twin of the technical system and/or of the network.

6. The node as claimed in claim 1, wherein the network comprises a network application or an infrastructure of a network application or a distributed database without a central entity.

7. The node as claimed in claim 1, wherein the technical system and the network for controlling the technical system are each part of an Internet of Things system.

8. The node as claimed in claim 1, wherein the node stores the transaction in a blockchain.

9. The node as claimed in claim 1, further programmed to:
if it was established that the transaction can be executed according to the validation requirement,
transfer the transaction on the basis of the successful simulation by the digital simulation, to the node which is intended to execute the transaction, using a transfer mechanism independent of a complete data replication in the network.

10. The node as claimed in claim 9, wherein the accelerated transfer mechanism comprises a Lightning protocol.

11. The node as claimed in claim 1, further programed to, upon execution of the transaction by the technical system, determine a quality of the validation of a node of the digital simulation by comparing the transaction validated by the digital simulation with the real execution of the transaction by the technical system.

12. The node as claimed in claim 11, wherein the node uses the quality of the validation of a node of the digital simulation to determine for the node of the digital simulation a dynamic weighting factor relative to other nodes of the digital simulation which factor is used in the validation of a following transaction.

13. The node as claimed in claim 1, wherein instead of one transaction, a multiplicity of transactions are validated for execution by a respective corresponding node configured to:
acquire a multiplicity of transactions each comprising control commands to be executed by a corresponding node of the mechanical installation;
determine an associated validation requirement for a respective transaction;
transfer the transactions and the associated validation requirements to a digital simulation of the technical system;
execute the transactions in the digital simulation to establish whether the transactions can be executed according to the associated validation requirements; and
if it was established that a predefined minimum number of nodes of the digital simulation can execute the corresponding transactions according to the associated validation requirements validating all the transactions for execution by the technical system.

14. A method for validating a transaction for execution by a node of a technical system, the method comprising:
acquiring a transaction comprising control commands to be executed by the technical system;
determining a validation requirement for the transaction;
transferring the transaction and the validation requirement to a digital simulation of the technical system; and
executing the transaction in the digital simulation to establish whether the transaction can be executed according to the validation requirement.

15. A network for controlling a technical system, the network comprising at least one node programmed to:
acquire a transaction comprising control commands to be executed by the technical system;
determine a validation requirement for the transaction;
transfer the transaction and the validation requirement to a digital simulation of the technical system; and
execute the control commands using the digital simulation to establish whether the transaction can be executed according to the validation requirement.
